(19) United States
(12) Patent Application Publication
(10) Pub. No.: US 2009/0252988 A1
(43) Pub. Date: Oct. 8, 2009

(54) COATED COMPONENTS FOR USE IN HIGH TEMPERATURE ENVIRONMENTS AND METHODS OF FORMING A COATING ON THE COMPONENT

(75) Inventors: Eric Passman, Piscataway, NJ (US); Reza Oboodi, Morris Plains, NJ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/062,805

(22) Filed: Apr. 4, 2008

(51) Int. Cl. B32B 15/00; B32B 9/00

(52) U.S. Cl. 428/696; 428/411.1; 428/689

(57) ABSTRACT

Coated components and methods of forming a coating on a component are provided. In an embodiment, by way of example only, a coated component includes a substrate and a coating overlying the substrate, where the coating comprises a plurality of agglomerates, each agglomerate including one or more particles of a first constituent and one or more particles of a second constituent that is different from the first constituent assembled into a structure. The structures of a majority of the plurality of agglomerates of the coating are identical to each other,

### TECHNICAL FIELD

The inventive subject matter generally relates to engine components for use in high temperature environments, and more particularly relates to coatings for the components and methods of forming the coatings.

### BACKGROUND

Foil bearings may be used to support rotating components of turbine engines, turbochargers, and the like. Generally, a foil bearing includes a journal mounted to the rotating component and a cylindrical top foil disposed around the journal. The journal and top foil are configured such that when the rotating component rotates at an optimum operational speed, the foil and the journal separate from each other to form an air gap. As the air gap between the foil and the journal grows, pressurized air is drawn in to serve as a load support and act as a lubricant to the rotating component and surrounding static components.

In the absence of the pressurized air between the journal and the top foil, the two components may come into contact each other or with other surrounding components. Thus, to protect the components from premature wear, one or more of the components may include a solid lubricant coating thereon. Solid lubricant coatings may be made up of a composition including inorganic constituents, such as a chromium oxide (e.g., chromic oxide, Cr₂O₃), a metal binder comprising a chromium/nickel or chromium/cobalt alloy, a metal fluoride, and, optionally, a metal lubricant. Typically, the composition may be powder-milled and then deposited on the component by high-temperature processes (e.g., greater than 800° C.), such as plasma spraying, and/or applied to the component and sintered at a high temperature to impart various properties to the coating. In other cases, the composition may be added to a liquid binder, which may include organic polymer constituents, and the component may be sprayed with or dipped into the liquid.

Although the aforementioned processes for coating the components are effective, they may be improved. For example, the high-temperature processes are typically not used for coating relatively small or thin components (e.g., components having a thickness of less than about 1.25 mm), such as the top foil, because the components may melt or sinter during processing. Similarly, the processes are typically not used for coating components made of materials having a melting temperature below that of the processing temperatures. Instead, the coatings may be formed using liquid binders; however, such processes may yield coatings which may be limited to operating temperatures of less than about 350° C.

Accordingly, it is desirable to have a solid lubricant coating that may be applied to a component, such that the component may operate in temperatures in excess of about 350° C. Additionally, it is desirable to have a method of forming the coating, which can be easily and inexpensively performed. It is also desirable for the method to be performed at temperatures that are below those which may thermally damage the component, while still allowing the solid lubricant coating to bond to the substrate surface. Furthermore, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

Coated components and methods of forming a coating on a component are provided.

In an embodiment, by way of example only, a coated component includes a substrate and a coating overlying the substrate, where the coating comprises a plurality of a first type of agglomerates, each agglomerate including one or more particles of a first constituent and one or more particles of a second constituent that is different from the first constituent assembled into a structure. The structures of a majority of the plurality of the first type of agglomerates of the coating are identical to each other.

In another embodiment, by way of example only, a coated component includes a substrate and a coating overlying the substrate. The coating includes a plurality of a first type of agglomerates and a plurality of a second type of agglomerates, where each agglomerate of the plurality of the first type of agglomerates including one or more particles of a first constituent and one or more particles of a second constituent assembled into a first structure, and each agglomerate of the plurality of the second type of agglomerates including one or more particles of a third constituent and one or more particles of a fourth constituent assembled into a second structure. The first structures of a majority of the plurality of the first type of agglomerates of the coating are identical to each other, and the second structures of a majority of the plurality of the second type of agglomerates of the coating are identical to each other. The first constituent and the second constituent are different from each other, and the third constituent and the fourth constituent are different from each other.

In yet another embodiment, by way of example only, a method includes forming a plurality of agglomerates, each agglomerate including one or more particles of a first constituent and one or more particles of a second constituent that is different from the first constituent assembled into a structure, wherein the structures of a majority of the plurality of agglomerates of the coating are identical to each other. The method also includes applying the plurality of agglomerates to a substrate to form the coating on the component.

### BRIEF DESCRIPTION OF THE DRAWINGS

The inventive subject matter will hereinafter be described in conjunction with the following drawing figures, wherein like numerals denote like elements, and

FIG. 1 is a cross section view of a component, according to an embodiment;

FIG. 2 is a close up view of a portion of the component of FIG. 1 indicated by dotted line 1, according to an embodiment;

FIG. 3 is a close up view of a portion of a component, according to another embodiment;

FIG. 4 is a simplified cross section view of an agglomerate, according to an embodiment;

FIG. 5 is a flow diagram of a method of forming a coating for a component, according to an embodiment;

FIG. 6 is a flow diagram of a step of the method in FIG. 5, according to an embodiment; and

FIG. 7 is a flow diagram of a step of the method in FIG. 5, according to an embodiment.

### DETAILED DESCRIPTION

The following detailed description is merely exemplary in nature and is not intended to limit the inventive subject matter or the application and uses of the inventive subject matter. Furthermore, there is no intention to be bound by any theory presented in the preceding background or the following detailed description.

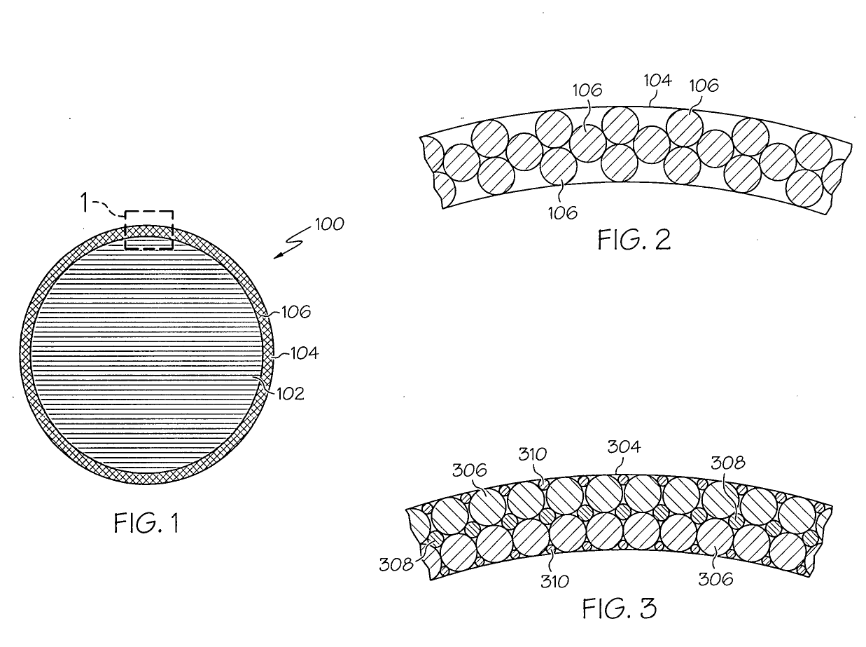

FIG. 1 is a cross section view of a component 100, according to an embodiment. The component 100 may be any component used in an aircraft, spacecraft, watercraft, landcraft, or any other vehicle or machine that may include components having a coating thereon. In an embodiment, the component 100 may be a bearing, such as a foil bearing, journal bearing, roller bearing, and the like. In another embodiment, the component 100 may be a rotating or a stationary turbine blade, airfoil, impeller, shroud, housing, strut, or other component that may be subjected to relatively high temperatures, such as those in excess of 350° C. In any case, the component 100 may be made up of a substrate 102 having a coating 104 thereon. The substrate 102 may be made of a metal, such as a nickel-based alloy, cobalt-based alloy, and the like, or other materials typically used for machine components. Although the substrate 102 of FIG. 1 is shown to have a circular cross section, substrates may have different geometrical cross-sectional shapes, in other embodiments.

The coating 104 is shown to completely surround the periphery of substrate 102, however a coating may only partially cover the periphery of a substrate, in other embodiments. In any case, in an embodiment, the coating 104 has a particular composition, and the composition is made up of particles of two or more constituents. As will be discussed in more detail below, the particles of the constituents are arranged within structures that are referred to herein as “agglomerates” 106. FIG. 2 is a close-up view of a portion of the coating 104 indicated in FIG. 1 by dotted line 1, according to an embodiment. In an embodiment, a plurality of a first type of agglomerates 106 makes up the coating 104. In this regard, at least a majority of the plurality of the first type of agglomerates 106 are identical in structure, in an embodiment. In another embodiment, all of the agglomerates of the plurality of the first type of agglomerates 106 are identical to each other in structure.

FIG. 3 is a close-up view of a portion of a coating 304 on a portion of a component 300, according to another embodiment. Here, three types of agglomerates 306, 308, 310 make up the coating 304. In this regard, at least a majority of the plurality of the first type of agglomerates 306 are identical in structure, at least a majority of the plurality of the second type of agglomerates 308 are identical in structure, and at least a majority of the plurality of the third type of agglomerates 310 are identical in structure, in an embodiment. In another embodiment, all of the agglomerates of the plurality of the first type of agglomerates 306 are identical to each other in structure, all of the agglomerates of the plurality of the second type of agglomerates 308 are identical to each other in structure, and all of the agglomerates of the plurality of the third type of agglomerates 310 are identical to each other in structure. Although the three types of agglomerates 306, 308 are shown as being substantially uniformly dispersed with respect to each other, they may not be in some embodiments. Additionally, although the first type of agglomerates 306 is shown as having particles that are larger than those of the second and third types of agglomerates 308, 310 they may alternatively be substantially identical (e.g., ±0.5 microns) in size, in other embodiments. In still other embodiments, the first type of agglomerates 306 may be smaller than the second and third types of agglomerates 308, 310. Moreover, in other embodiments, the coating 304 may be made up of two types or more than three types of agglomerates of substantially identical or varying sizes.

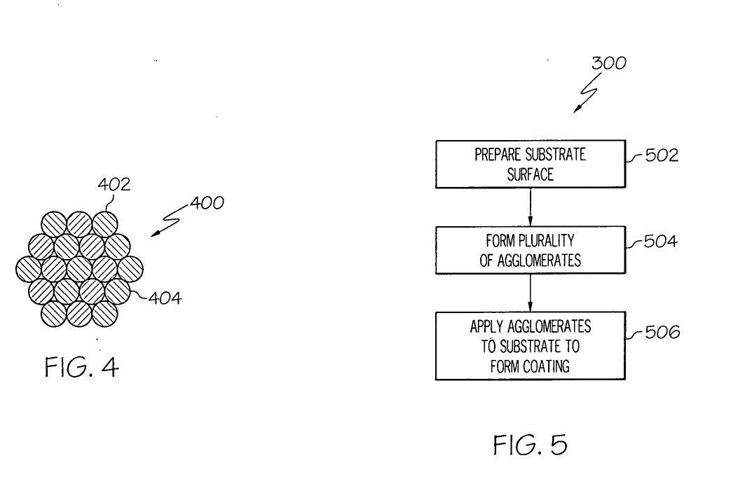

FIG. 4 is a simplified, cross section view of an agglomerate 400, according to an embodiment. In an embodiment, the agglomerate 400 includes several particles of a first constituent 402 and several particles of a second constituent 404. The particles of each of the constituents 402, 404 form a structure. Although the structure is shown as being substantially two-dimensional, it will be appreciated that structure may be three-dimensional in other embodiments. Moreover, although a first number of particles of the first constituent 402 and a second number of particles of the second constituent 404 are depicted as forming the agglomerate 400 in this embodiment, it will be appreciated that fewer or more particles of the first constituent may be included in other embodiments. Similarly, fewer or more particles of the second constituent may be included in still other embodiments. Additionally, although all of the constituents appear to be substantially identical in size, they may not be in other embodiments. For example, one constituent (e.g., the first constituent 402) may be larger or smaller than another constituent (e.g., the second constituent 404).

Although the agglomerate 400 is shown as including two different constituents 402, 404, the number of constituents in the composition of the agglomerate 400 depends on a particular formulation of the resultant coating 104, 304 (FIGS. 1-3). For example, the coating 104, 304 may have a composition that forms a solid film lubricant, and the composition may be composed of one or more agglomerate of one or more types including one or more constituents that make up the solid film lubricant. In other embodiments, the agglomerate 400 may include more than two constituents.

In one embodiment, a solid film lubricant formulation may include a constituent that is a material capable of providing solid film lubricant properties to a coating. In an example, the constituent may be an inorganic material. Suitable inorganic materials exhibiting such properties include, but are not limited to one or more metal sulfides, metal fluorides, and/or precious metals. In an embodiment, suitable metal sulfides include, but are not limited to MoS₂. In another embodiment, suitable metal fluorides include, but are not limited to fluorides of at least one metal selected from the group consisting of a Group IA alkali earth metal, a Group IIA alkaline earth metal, rare earth metal, and mixtures thereof. In other embodiments, suitable precious metals exhibiting solid film lubricant properties may include, but are not limited to silver, gold, platinum, palladium, rhenium, copper and mixtures thereof.

In another embodiment, the inorganic material may be selected for an ability to serve as a bonding component for the solid film lubricant. In an example, a suitable inorganic material may be a mixture selected for an ability to melt at a lower temperature than a temperature at which individual components of the mixture may melt. In this regard, the inorganic material may be an inorganic eutectic mixture. Suitable inorganic eutectic mixtures include, but are not limited to silver sulfide/copper sulfide, silver sulfide/lead sulfide, silver sulfide/bismuth sulfide, nickel oxide/vanadium pentoxide, and calcium fluoride/magnesium fluoride. In another example, the inorganic material may be a bonded metal alloy suitable for acting as the bonding component. Suitable bonded metal alloys include, but are not limited to a metal bonded chromium oxide (Cr₂O₃), where the bonding metal may be an alloy containing chromium and at least one of nickel, cobalt or mixtures thereof.

In still another embodiment, the inorganic material may be selected for having an ability to provide wear-resistance properties to the solid film lubricant. In such case, the inorganic material may be a metal oxide, such as chromic oxide, nickel oxide, aluminum oxide, barium oxide or another metal oxide.

As mentioned briefly above, the composition of the solid film lubricant may include one or more constituents. In such case, a first constituent and a second constituent may be different from each other, in an embodiment. In another example, the first constituent may be an inorganic material, such as a metal or alloy thereof, and the second constituent may be an inorganic material that is different than the first constituent but that is a material similar to one that could be included as the first constituent, in an embodiment. For example, in an embodiment, the solid film lubricant may include a first constituent that is an inorganic material capable of providing solid film lubricant properties and a second component capable of serving as a bonding component. In particular, the first constituent may be one or more metal sulfides, one metal fluorides, and/or one precious metals, while the second constituent may be an inorganic eutectic mixture. In another example, the solid film lubricant may include a first constituent that includes an inorganic material capable of providing solid film lubricant properties and the second constituent may be an inorganic material that is capable of serving as a wear-resistant component of the solid film lubricant material.

In another embodiment, the first constituent may be selected from the materials mentioned above, and the second constituent may be a binder. For example, the binder may be an organic or inorganic binder. Suitable organic binders include, but are not limited to organic polymer binders, such as ethyl cellulose and nitrocellulose. Inorganic binders that may be incorporated include, but are not limited to fluoride glasses.

In other embodiments, a third constituent is included with the first and the second constituents. The third constituent may be an inorganic material that is different than the first and the second constituents but that is a material that is selected from those materials mentioned above as being suitable for inclusion as the first or second constituents, in an embodiment. For example, the first constituent may include an inorganic material capable of providing solid film lubricant properties, the second constituent may include an inorganic material capable of serving as a bonding component, and the third constituent may include an inorganic material that is capable of serving as a wear-resistant component of the solid film lubricant material.

In still another embodiment, the third constituent may include a non-metallic component that is added to the first and the second constituents to form the solid film lubricant formulation. Suitable non-metallic components include, but are not limited to ceramics, silicates, and/or binders. Suitable examples of ceramics include, but are not limited to Cr₂O₃, Al₂O₃, and TiO₂. Suitable examples of silicates include, but are not limited to sodium silicate. The binder may be an organic or inorganic binder. For example, suitable organic binders include, but are not limited to organic polymer binders, such as ethyl cellulose and nitrocellulose. Inorganic binders that may be incorporated include, but are not limited to fluoride glasses. In still yet other embodiments, more than three constituents may make up the agglomerate 400, for example, four, five, six or even more different constituents may be included, in an embodiment.

As alluded to above, in an embodiment in which two or more types of agglomerates make up the coating 304, differing embodiments of the agglomerate 400 may be used as each agglomerate type. Thus, for instance, a first type of agglomerate may include a first constituent and a second constituent that is different than the first constituent, and a second type of agglomerate may include a third constituent and a fourth constituent that is different than the third constituent. In an embodiment, all of the constituents may differ from each other; however, in other embodiments, one constituent of the first type of agglomerate and one constituent of the second type of agglomerate may be substantially identical material.

No matter the particular formulation of the resultant coating, the particles (e.g., particles 402, 404) of each agglomerate 400 are relatively small and have diameters (or maximum dimensions) in a range of about 1 nm to about 100 nm. As a result, each agglomerate 200 may have a diameter in a range of about less than 1 micron to about 30 microns. In another embodiment, each of the agglomerates 400 has a diameter of about two (2) microns. Each agglomerate 400 may be spherically-shaped; however, the particular shape of an agglomerate may depend on the number of particles and the type of constituents used in its composition, and therefore each agglomerate 400 may be other than spherically-shaped.

To form a coating made up of the plurality of agglomerates, a method 500 depicted in FIG. 5 may be employed. In an embodiment, the method 500 includes preparing a surface of a substrate to be coated, step 502. In an example, surface preparation may include a chemical process. For example, the substrate surface may be chemically etched to provide a micro-roughened surface adapted for bonding the agglomerates thereto. In an embodiment, the substrate surface may be chemically etched by applying a chemical etchant thereto. Suitable chemical etchants include, but are not limited to a solution of ferric chloride (e.g., 40 wt. % ferric chloride in water) and a dilute mineral acid. In another example, surface preparation may include oxidizing the substrate surface to form an oxide film thereon. In an embodiment, the substrate surface may be oxidized by exposure to heat in the presence of air. For example, the substrate and the air may be heated to a temperature in a range of between about 500° C. to about 1000° C. or any other temperature suitable for promoting oxidation. In still another example, the substrate surface may be cleaned. In one embodiment, the substrate surface is rinsed with deionized water to remove any traces of chemical etchant, if used, or to remove dust or other unwanted particles.

Either before or after surface preparation, the plurality of agglomerates is formed, step 504. In an embodiment, the plurality of agglomerates is comprised of agglomerates that each includes one or more particles of one or more constituents, where the particles are assembled into a structure and the structures of a majority of the plurality of agglomerates are substantially identical to each other. Thus, in an embodiment, the one or more constituents are first selected and/or identified. The one or more constituents may be selected from the constituents described above. For example, the agglomerates may comprise one or more particles of a first constituent and one or more particles of a second constituent, where the two constituents different from each other. In an embodiment, the first constituent comprises a metal or alloy thereof, and the second constituent comprises an inorganic material that is different from the first constituent. In another example, a third constituent may be added, where the third constituent comprises one or more non-metallic components, including, but not limited to ceramics, silicates, and/or binders. In other embodiments, more than two or three constituents may be used. In embodiments in which more than one type of agglomerates is employed, it will be appreciated that each type of agglomerate may be formed by step 504.

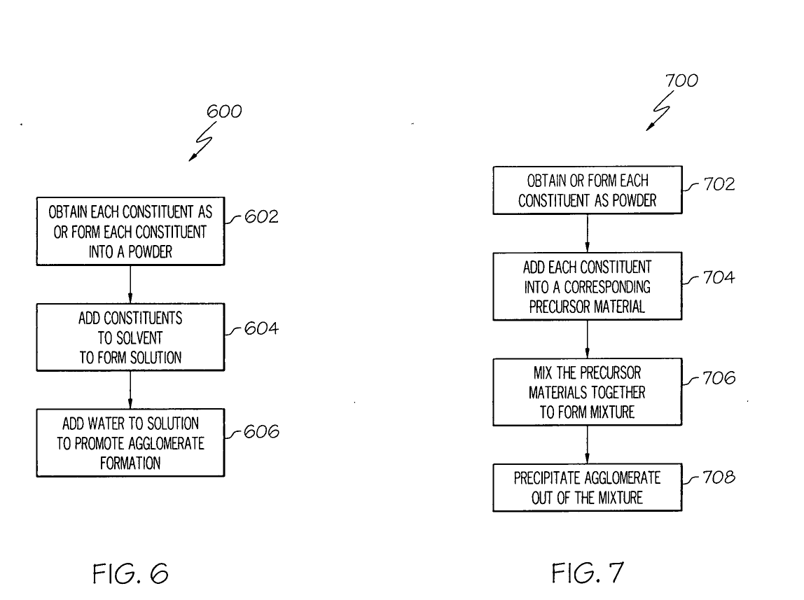

FIG. 6 is a flow diagram of a method 600 of forming the agglomerates from the constituents, according to an embodiment. After the constituents are selected or identified, each is either obtained as or formed into a powder, step 602. Substantially all (e.g., at least 90%) of the particles included in the powders of each constituent have diameters in a range of about 1 nm to about 100 nm. To obtain powder particles of such sizes, the constituents may be pulverized, milled, or precipitated. The powdered constituents also may be filtered to filter out particles of undesired sizes.

Next, an amount of each of the constituents is added into a solvent to form a solution, step 604. The particular amount of each of constituent may depend on the particular resultant coating desired. For example, in an embodiment in which a resultant coating is made up of about 80% by weight of zinc and 20% by weight of gallium, corresponding amounts of the inorganic materials may be included. The constituents may be suspended in the solvent, in an embodiment. In another embodiment, the constituents may simply be dissolved in the solvent. In an embodiment, the solvent may be a non-polar solvent such an alcohol, such as butanol, or other solvent such as toluene. In another embodiment, the solvent may be a polar solvent.

After the constituents are added to the non-polar solvent, water is added to the solution to promote agglomerate formation, step 606. In an embodiment, an intermediate phase forms between the non-polar solvent and the water, and the constituents self-assemble into agglomerates, a majority of which are identical in structure to each other. Self-assembly may occur while the constituents migrate from the non-polar solvent into the water upon the application of a thermal or chemical catalyst. In another embodiment, the solution and the water are emulsified, and the non-polar solvent is subsequently evaporated. In this case, van der Waals forces between particles of the constituents may cause the particles to become attracted to each other and to self-assemble into agglomerates.

FIG. 7 is a flow diagram of a method 700 of forming the agglomerates from the constituents, according to another embodiment. Similar to method 600, method 700 includes obtaining or forming the constituents into powder, step 702. In an embodiment, each of the powder constituents is added to a corresponding precursor material, step 704. For example, the first constituent may be included as part of a first precursor material, while the second constituent may be included as part of a second precursor material. Each precursor material may include components other than the included constituent. Additionally, each precursor material may be a liquid including the constituent in powder form suspended therein. Alternatively, the precursor materials may be powders. Next, the precursor materials are mixed with each other to form a mixture, step 706. For example, the precursor materials may be disposed in a single container and a mixer may be placed therein to mix the materials. In any case, upon application of a thermal or chemical catalyst, or in some embodiments, upon mixing, the constituents (e.g., the first and the second constituents) may precipitate out of the mixture as assembled agglomerates, step 708.

Returning to FIG. 5, after the agglomerates are formed, they are applied to a substrate to form a coating thereon, step 504. In an embodiment in which the agglomerates include a binder as a constituent, the agglomerates may be mixed with a liquid to form a paste. In embodiments in which the agglomerates do not include a binder as a constituent, the agglomerates may be mixed with a liquid, which may or may not include a binder, to form a paste. The liquid may be deionized water, alcohol, or other suitable solvent. In any case, the paste may have a viscosity in a range of from about 50,000 to 300,000 Centipoise, in an embodiment. In another embodiment, the viscosity of the paste may be in a range from about 100,000 to 300,000 Centipoise, but may, in other embodiments, be in a range of from about 100,000 to 250,000 Centipoise. In an embodiment in which two or more types of agglomerates form the coating, appropriate ratios of each agglomerate type are mixed together, and the liquid may be added thereto to form the paste.

The paste may then be applied to the substrate. In an example, the paste may be applied to the substrate by a thick film screen printing process. In an embodiment, a mesh screen is placed over a portion of the substrate to be coated, and the paste is pressed through the mesh onto the substrate. Any marks remaining on the substrate from the mesh may be removed by a subsequent polishing process. In another embodiment, the paste may be formed into a tape and the tape may be transferred to the substrate. In other embodiments, alternate application processes may be employed. For example, the paste may be painted or brushed onto the substrate, or the paste may be sprayed, printed, cast or doctor-bladed onto the substrate.

After the paste is disposed over the substrate, it may be air dried, in an embodiment. In another embodiment, the paste may be dried by heating to a first temperature sufficient to remove substantially all liquid therefrom. In an embodiment, the first temperature may be in a range of from about 85° C. to 150° C. In another embodiment, the first temperature may be in a range of from about 95° C. to 150° C. In still another embodiment, the first temperature may be in a range of from about 100° C. to 150° C. The first temperature may be maintained for a time period in a range of from about 5 minutes to 60 minutes, in an embodiment. In still another embodiment, the substrate may be subjected to a heat treatment at a second temperature to impart desired properties into the resultant coating. For instance, the second temperature may be greater than the first temperature and may be sufficient to melt the constituents in the paste without melting the substrate. In an example, the second temperature may be in a range of from about 600° C. to 1200° C.

Because the agglomerates of each agglomerate type are substantially identical to each other in structure, the constituents of the resultant coating are more uniformly distributed therethrough, as compared to conventionally formed coatings. As a result, the coating may have improved resistance to wear and corrosion over conventionally processed coatings, because the intimate mixture and increased contact between the various coating constituents allows increased sintering and oxidation protection. The coating may be used on components subjected to temperatures in excess of 350° C. Additionally, by assembling agglomerates that include nano-sized particles, coating processes may be more safely performed. Moreover, sintering temperatures of coatings comprising the agglomerates may be lower than coatings without the agglomerates, which may simplify coating processes as well.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A coated component comprising:
a substrate; and
a coating overlying the substrate, the coating comprising a plurality of a first type of agglomerates, each agglomerate including one or more particles of a first constituent and one or more particles of a second constituent that is different from the first constituent assembled into a structure,
wherein the structures of a majority of the plurality of the first type of agglomerates of the coating are identical to each other.

2. The component of claim 1, wherein the first constituent comprises a metal or alloy thereof, and the second constituent comprises an inorganic material that is different than the first constituent.

3. The component of claim 2, wherein the metal or alloy thereof comprises a material selected from the group consisting of a metal sulfide, a metal fluorides, and/or a precious metal.

4. The component of claim 2, wherein the inorganic material of the second constituent comprises a material selected from the group consisting of an inorganic eutectic mixture, a bonded metal alloy, and a metal oxide.

5. The component of claim 4, wherein the inorganic eutectic mixture comprises one or more components selected from the group consisting of silver sulfide/copper sulfide, silver sulfide/lead sulfide, silver sulfide/bismuth sulfide, nickel oxide/vanadium pentoxide, and calcium fluoride/magnesium fluoride.

6. The component of claim 4, wherein the bonded metal alloy comprises a metal bonded chromium oxide (Cr₂O₃), where the bonding metal may be an alloy containing chromium and at least one of nickel, cobalt or mixtures thereof.

7. The component of claim 4, wherein the metal oxide of the second constituent comprises a material selected from the group consisting of nickel oxide, aluminum oxide, chromic oxide, and barium oxide.

8. The component of claim 1, wherein each agglomerate further includes one or more particles of a third constituent assembled with the one or more particles of the first constituent and the one or more particles of the second constituent into the structure, the third constituent comprising a material selected from a group consisting of a ceramic, a silicate, and a binder.

9. The component of claim 1, wherein the second constituent comprises a binder.

10. A coated component comprising:
a substrate; and
a coating overlying the substrate, the coating comprising a plurality of a first type of agglomerates and a plurality of a second type of agglomerates, each agglomerate of the plurality of the first type of agglomerates including one or more particles of a first constituent and one or more particles of a second constituent assembled into a first structure, and each agglomerate of the plurality of the second type of agglomerates including one or more particles of a third constituent and one or more particles of a fourth constituent assembled into a second structure,
wherein:
the first structures of a majority of the plurality of the first type of agglomerates of the coating are identical to each other,
the second structures of a majority of the plurality of the second type of agglomerates of the coating are identical to each other;
the first constituent and the second constituent are different from each other, and
the third constituent and the fourth constituent are different from each other.

11. The coated component of claim 10, wherein the first constituent and the third constituent comprise substantially identical materials.

12. A method of forming a coating on a component, the method comprising the steps of:
forming a plurality of agglomerates, each agglomerate including one or more particles of a first constituent and one or more particles of a second constituent that is different from the first constituent assembled into a structure, wherein the structures of a majority of the plurality of agglomerates of the coating are identical to each other; and
applying the plurality of agglomerates to a substrate to form the coating on the component.

13. The method of claim 12, wherein the step of forming the plurality of agglomerates comprises:
adding the particles of the first constituent and the particles of the second constituent into a non-polar solvent;
emulsifying the non-polar solvent and water to form a suspension; and
evaporating the non-polar solvent from the suspension to form the plurality of agglomerates.

14. The method of claim 12, wherein the step of forming the plurality of agglomerates comprises:
mixing a first precursor including the particles of the first constituent with a second precursor including the particles of the second constituent to form a mixture; and
precipitating the plurality of agglomerates out of the mixture.

15. The method of claim 12, wherein the first constituent comprises a metal or alloy thereof comprising a material selected from the group consisting of a metal sulfide, a metal fluoride, and/or a precious metal.

16. The method of claim 12, wherein the second constituent comprises an inorganic material comprising a material selected from the group consisting of an inorganic eutectic mixture, a bonded metal alloy, a metal oxide, and a binder.

17. The method of claim 16, wherein the inorganic eutectic mixture comprises one or more components selected from the group consisting of silver sulfide/copper sulfide, silver sulfide/lead sulfide, silver sulfide/bismuth sulfide, nickel oxide/vanadium pentoxide, and calcium fluoride/magnesium fluoride.

18. The method of claim 16, wherein the metal oxide of the second constituent comprises a material selected from the group consisting of nickel oxide, aluminum oxide, chromic oxide, and barium oxide.

19. The method of claim 16, wherein the bonded metal alloy comprises a metal bonded chromium oxide (Cr₂O₃), where the bonding metal may be an alloy containing chromium and at least one of nickel, cobalt or mixtures thereof.

20. The method of claim 12, wherein each agglomerate further includes one or more particles of a third constituent assembled with the one or more particles of the first constituent and the one or more particles of the second constituent into the structure, the third powder comprising a material selected from a group consisting of a ceramic, a silicate, and a binder.
